(19) United States
(12) Patent Application Publication
(10) Pub. No.: US 2014/0379601 A1
(43) Pub. Date: Dec. 25, 2014

(54) SYSTEM, APPARATUS, DEVICE, METHOD AND COMPUTER-READABLE MEDIUM

(71) Applicant: FUJITSU LIMITED, Kawasaki-shi (JP)

(72) Inventor: Tetsuro TAKAHASHI, Yokohama (JP)

(73) Assignee: FUJITSU LIMITED, Kawasaki-shi (JP)

(21) Appl. No.: 14/296,707

(22) Filed: Jun. 5, 2014

(30) Foreign Application Priority Data
Jun. 20, 2013 (JP) 2013-129460

(51) Int. Cl. G06Q 50/20; G06F 17/30; G06Q 10/00

(52) U.S. Cl. CPC G06Q 50/20; G06Q 10/00; G06F 17/30943; G06F 17/30091
USPC 705/326

(57) ABSTRACT

A system includes a database configured to store pieces of data each of which corresponds to learning materials; an apparatus configured to: obtain order information defining relationship between a plurality of learning items and learning order for the plurality of learning items, identify which learning item among the plurality of learning items each of the pieces of data relates to, and determine order relation between the pieces of data based on order of each the identified learning item in the order information; and a device configured to access the pieces of data each of which corresponds to the learning materials based on the determined order relation.

### CROSS-REFERENCE TO RELATED APPLICATION

This application is based upon and claims the benefit of priority of the prior Japanese Patent Application No. 2013-129460, filed on Jun. 20, 2013, the entire contents of which are incorporated herein by reference.

### FIELD

An embodiment discussed herein is related to a system, an apparatus, a device, a method and a computer-readable medium.

### BACKGROUND

A system in which a user registers educational learning materials in a database, and other users are able to use the educational learning materials that have been registered is known. In this system, basically, anyone may become a provider of educational learning materials and anyone may use the registered educational learning materials.

Since such educational learning materials described above may be registered by any user, a large amount of educational learning materials are stored in the database. The users of the educational learning materials may freely select the educational learning materials that may suit their preferences from amongst the large amount of educational learning materials, using descriptions attached to the educational materials as clues.

In addition, there are university lectures that are open to the public. For example, video footage of a lecture which actually took place at a university may be viewable, and text documentation created based on the lecture may be obtainable. Furthermore, educational learning materials such as video footage may, for example, be grouped hierarchically in accordance with subjects such as mathematics and physics or with each course for every six months, and in the lowest layer of this hierarchy, educational learning materials are arranged in lecture order. By university lectures being exposed in these ways, it is possible for not only the students belonging to universities but also for other members of the public to enjoy educational opportunities.

When editing a lecture video, there is a technique to put breaks into the video, triggered by presentations of auxiliary materials by the lecturer. Another technique is known, in which portions not consistent between educational materials are extracted, by determining whether a non-described noun used in an educational material has been previously described in a previous educational material or not, so that it may be determined whether the term is new or has already appeared. Furthermore, another technique is known, in which the order of educational materials is presented, using learning items to be learnt in advance by the learner, or educational materials to which the learning goals to be achieved by learning have already been assigned.

Japanese Laid-open Patent Publication Nos. 2000-259071, 2003-287998, and 08-95951 are examples of the above related arts.

### SUMMARY

According to an aspect of the invention, an system includes a database configured to store pieces of data each of which corresponds to learning materials; an apparatus configured to: obtain order information defining relationship between a plurality of learning items and learning order for the plurality of learning items, identify which learning item among the plurality of learning items each of the pieces of data relates to, and determine order relation between the pieces of data based on order of each the identified learning item in the order information; and a device configured to access the pieces of data each of which corresponds to the learning materials based on the determined order relation.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a determination system for the order relation between educational materials in an embodiment.

FIG. 2 illustrates an example of educational material management information in the embodiment.

FIG. 3 illustrates an example of curriculum management information in the embodiment.

FIG. 4 illustrates an example of curriculum information in this embodiment.

FIG. 5 illustrates an example of order determination information in the embodiment.

FIG. 6 illustrates an example of educational material order information in the embodiment.

FIG. 7 illustrates an example of a process in a method of determining the order relation between educational materials in the embodiment.

FIG. 8 illustrates an example of a process of a similarity calculation in the method of determining the order relation between educational materials in the embodiment.

FIG. 9 illustrates an example of a process of an order determination in the method of determining the order relation between educational materials in the embodiment.

FIG. 10 illustrates an example of a process of a comprehensive order determination in the method of determining the order relation between educational materials in the embodiment.

### DESCRIPTION OF EMBODIMENT

First, according to the consideration by the inventor(s), even if it is possible to freely use multiple educational materials, when the order relation between the educational materials is not defined, it is unable to determine in which order the educational materials may be utilized.

According to an embodiment described below, it is possible to determine the learning order of multiple educational materials which are not associated with learning order in advance.

The consideration by the inventor(s) will further be explained. When the relevance between educational materials for learning is identified by a method such as keyword search, it is possible to choose similar educational materials. However, choosing similar educational materials does not necessarily ensure systematic and efficient learning possible.

For example, when studying a particular educational material, the learning efficiency is expected to be further enhanced when educational materials which are preferred to be studied after the particular educational material are presented, or educational materials which are suitable for the review of the particular educational material are presented. This presentation of educational materials based on learning order may not be carried out simply based on the relevance of the contents as to whether the educational materials are similar or not.

As described above, in the act of learning, the order of learning highly affects the efficiency of learning. Therefore, even when a large amount of educational materials is available to choose from, unless order relations are associated between the educational materials, the user of these educational materials may choose the educational materials solely based on their discretion. Thus, it may not be said that the learning efficiency is high.

Furthermore, there is a case in which educational materials are organized by creators of the educational materials, and the order relations are associated between the educational materials. For example, when university lectures are to be made open to the public, the lectures to be made open to the public are arranged according to a curriculum of the university. However, lectures to be made open to the public are organized in accordance with curriculums of individual universities. Therefore, the order relations between the lectures are not organized between the universities.

Furthermore, although a lecture order organized by a university is arranged in a systematic way, the lecture order is simply a fragment of a learning order of a particular subject from a particular university's point of view, and it may be said that it is only an example of a recommended order when learning.

Therefore, when studying lectures made open to the public by a particular university by following the curriculum of the particular university, even when a high-quality educational material which is made open to the public by another university is available, because the order relation between this high-quality educational material and the learning phase of the lectures is unknown, an opportunity of cross-cut learning across universities may be missed. Thus, it may be said that opportunities for comprehensive learning programs which meet the demand of users of the educational materials are not provided.

According to the embodiment described below, even in the case where learning orders are not associated with each other amongst multiple educational materials, by identifying which lecture of the curriculum is similar to the educational materials by using, as a mediator, information about the curriculum in which the lecture order is defined, it is possible to determine the order relations between the educational materials. Therefore, it is possible to present efficient learning order based on the determined order relation.

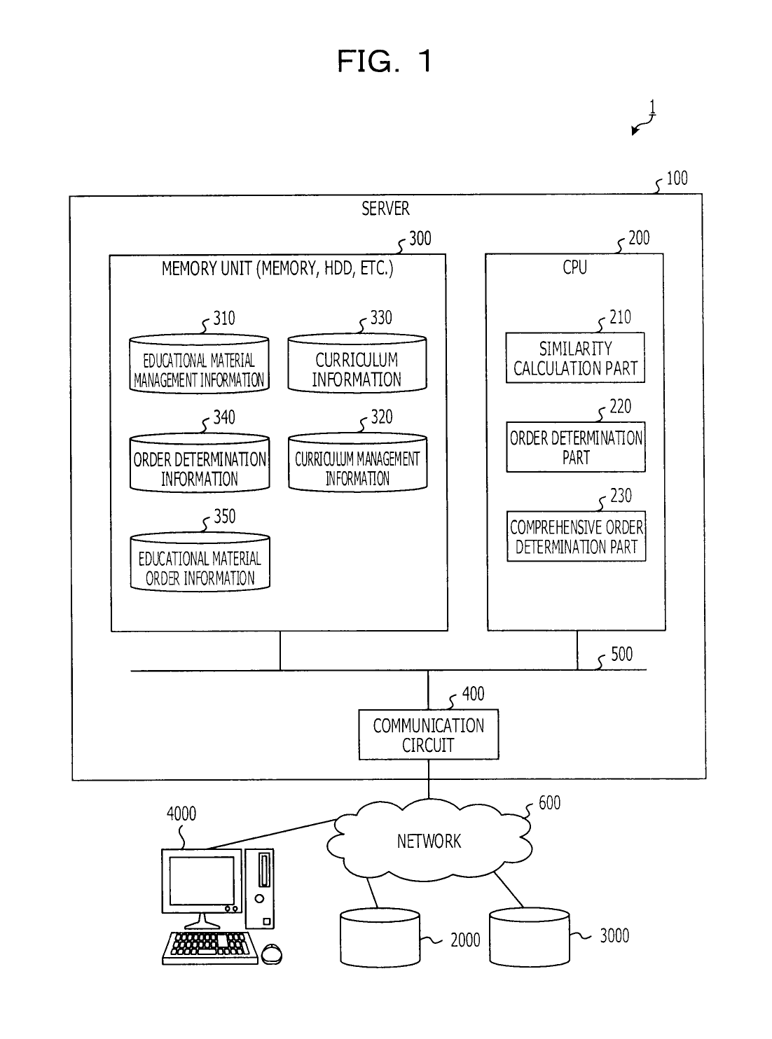

In FIG. 1, an example of a determination system for the order relation between educational materials is illustrated. The determination system 1 for the order relation between educational materials includes a server 100, an educational material database 2000, an educational material database 3000, and a terminal device 4000.

The server 100 is an example of an apparatus for determining the order relation between educational materials, and includes a central processing unit (CPU) 200, a memory unit 300, a communication circuit 400, and a bus 500 to connect the above components together. The server 100 communicates with an external network 600 via the communication circuit 400.

The memory unit 300 stores programs that perform various types of processing for the server 100. The CPU 200 reads out programs from the memory unit 300 and performs various types of processing. Furthermore, with the execution of various types of processing performed by the CPU 200, writing in and reading out of data to and from the memory unit 300 are performed. As will be described in detail later, the memory unit 300 stores information, such as educational material management information 310, curriculum management information 320, curriculum information 330, order determination information 340, educational material order information 350, and the like. In the embodiment, the memory unit 300 is not limited to one unit, unlike those illustrated FIG. 1. The memory unit 300 may be implemented by a plurality of memory units connected to the bus 500. Furthermore, the information mentioned above may also be stored across a plurality of memory units.

The educational material databases 2000 and 3000 are connected to the network 600. Data of educational materials are stored in the educational material databases 2000 and 3000, and are managed by the creators or the distributors of the educational materials. The server 100 accesses the educational material databases 2000 and 3000, and the educational material management information 310 to be stored in the memory unit 300 is created based on the contents of the educational materials stored in the educational material databases 2000 and 3000. Furthermore, the curriculum management information 320 and the curriculum information 330 to be stored in the memory unit 300 are created, for example, in accordance with information provided by the creators or the distributors of the educational materials.

The CPU 200 may include one or more CPU cores to perform various types of processing. Furthermore, each CPU core may include one or more processors. The memory unit 300 may, for example, be a random access memory (RAM) such as dynamic random access memory (DRAM), a nonvolatile memory such as a flash memory, a magnetic disk device such as a hard disk drive (HDD), or the like.

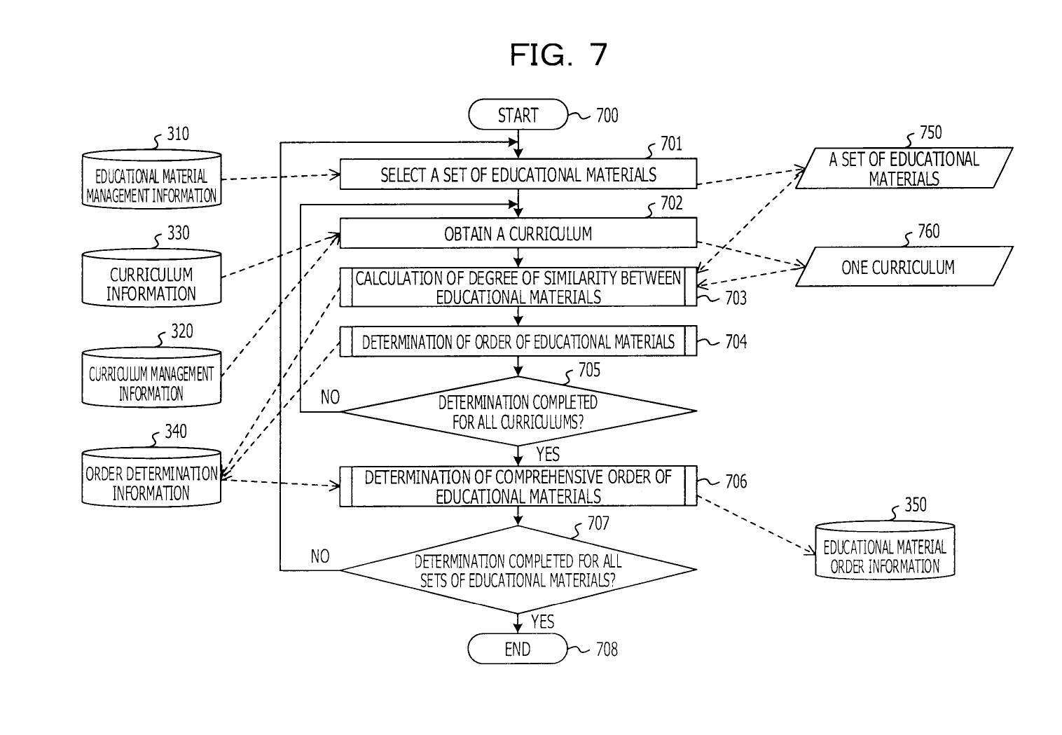

Furthermore, since a program loaded onto the memory unit 300 used as a working memory is executed by the CPU 200, the server 100 functions as a similarity calculation part 210 which functions as an obtaining part, an order determination part 220 which functions as a determination part, and a comprehensive order determination part 230 which functions as a decision part. The processes performed by individual functional blocks illustrated in FIG. 1 will be described later in association with the processes illustrated in FIGS. 7 to 10.

The terminal device 4000 is a computer including a CPU, a memory, a communication circuit, an input circuit, a display device, and the like. When using educational materials stored in the educational material databases 2000 and 3000, the terminal device 4000 requests the educational material order information 350 to the server 100, obtains the educational material order information 350, and in accordance with the order relation between the educational materials defined in the educational material order information 350, obtains and uses data of the educational materials from the educational material databases 2000 and 3000. In the following descriptions, an example for creating the educational material order information 350 by the server 100 will be explained. However, the same function as the server 100 may be implemented by using the hardware configuration of the terminal device 4000. Therefore, the educational material order information 350 may be created by the terminal device 4000.

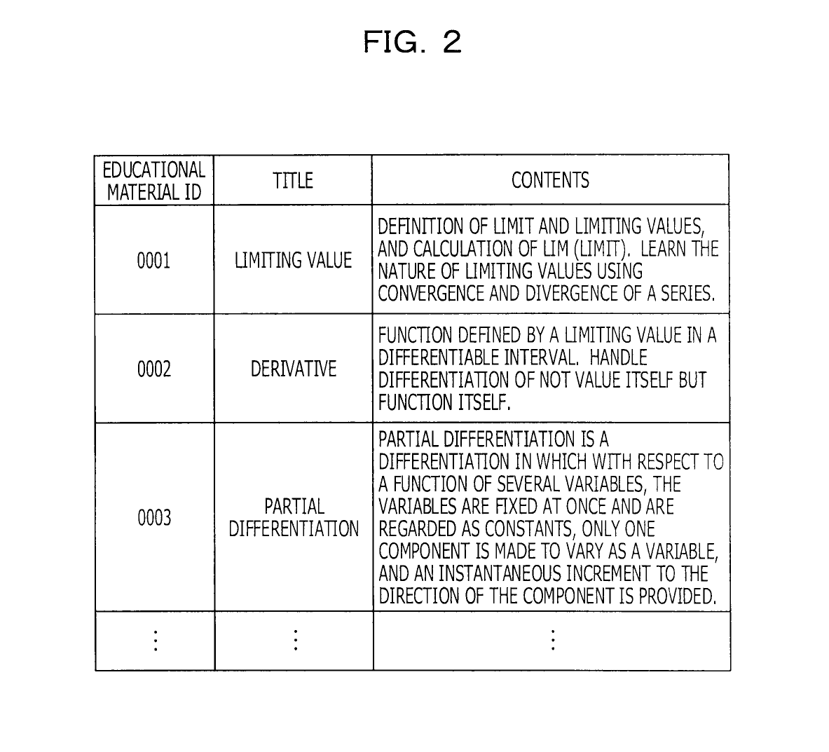

FIG. 2 illustrates an example of educational material management information in the embodiment. The educational material management information illustrated in FIG. 2 is an example of management information, such as the educational material management information 310 stored in the memory unit 300 which is illustrated in FIG. 1, for managing educational materials. Based on the contents of the educational materials registered in the educational material databases 2000 and 3000, educational material identifications (IDs) for uniquely identifying educational materials, titles of the educational materials, and descriptions of the contents of the educational materials are associated with one another, and the associations are registered into the educational material management information 310.

In the educational material management information 310 illustrated in FIG. 2, for example, information of an educational material is managed in an identifiable way in which an educational material having an educational material ID “0001” has a title “Limiting Value” and the contents of the educational material is “Definition of limit and limiting values, and calculation of lim (limit). Learn the nature of limiting values using convergence and divergence of a series”. Educational materials that the embodiment is applied to are not limited to mathematics such as the educational materials illustrated in FIG. 2. The educational materials may encompass all genres that may be registered in the memory unit 300.

The educational material management information 310 is referred to when obtaining a set of educational materials in processing 701, illustrated in FIG. 7.

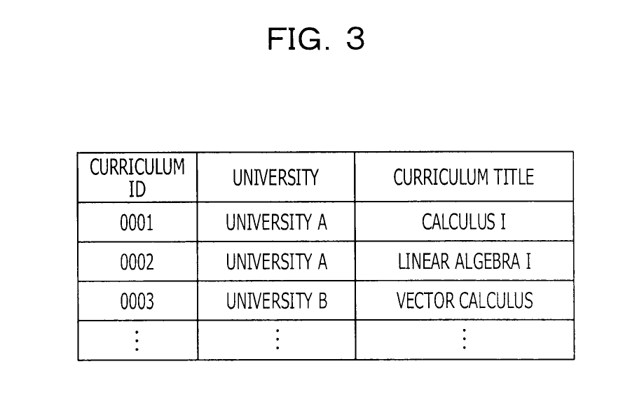

FIG. 3 illustrates an example of curriculum management information in the embodiment. The curriculum management information illustrated in FIG. 3 is an example of the curriculum management information 320 stored in the memory unit 300, which is illustrated in FIG. 1. The curriculum management information 320 is information used for managing curriculums. In the curriculum management information 320, curriculum IDs to uniquely identify curriculums, creators of the curriculums, and titles of the curriculums are registered in association with one another.

In the curriculum management information 320 illustrated in FIG. 3, for example, information on a curriculum is managed in an identifiable way in which a curriculum having a curriculum ID “0001” is created by “University A” and the title of the curriculum is “Calculus I”.

The curriculum management information 320 is referred to when obtaining a curriculum in processing 702, illustrated in FIG. 7.

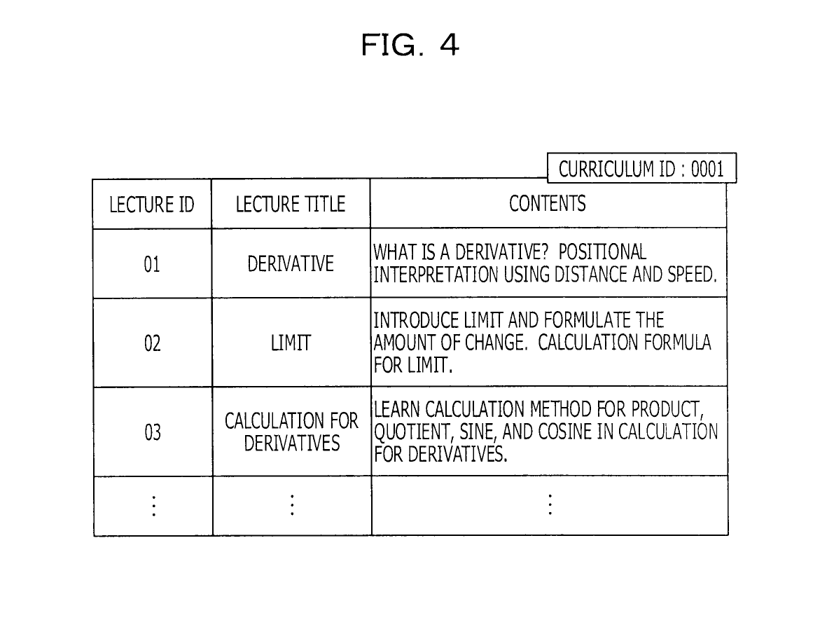

FIG. 4 illustrates an example of curriculum information in the embodiment. The curriculum information illustrated in FIG. 4 is an example of order information, such as the curriculum information 330 stored in the memory unit 300 which is illustrated in FIG. 1, for managing curriculum contents. In the curriculum information 330, for example, lecture IDs to uniquely identify lectures included in the curriculum and the order of the lectures, titles of the lectures, and written or verbal descriptions of the contents of the lectures, are registered in association with one another. Therefore, it may be said that by the curriculum information 330, examples of multiple learning items and the learning order when studying the multiple learning items are defined.

The curriculum information 330 is information which is created for each curriculum managed in the curriculum management information 320 illustrated in FIG. 3. That is, the curriculum information 330 for the number of the curriculums is stored in the memory unit 300.

For example, a description will be provided on the assumption that the curriculum information 330 illustrated in FIG. 4 has been created in association with the curriculum ID “0001” illustrated in FIG. 3. In this case, a lecture ID “01” is given to the first lecture “Derivative” of a curriculum “Calculus 1”, and a description of the lecture contents; “What is a derivative? Positional interpretation using distance and speed.” is associated with the lecture ID “01” and managed in the curriculum information.

The embodiment is not limited to lectures, and in the curriculum information 330, an example of a preferred learning order for a particular area of studies only may be identified. For example, when studying judicial precedents, it is expected that the learning efficiency will be further enhanced when the educational materials are studied in chronological order or the like, instead of in the registration order of the educational materials that describe the precedents. Thus, when a particular area of studies is identified, instead of the registration order in an educational material database, information on which the preferred learning order for the area of studies is based is used as the curriculum information 330.

Furthermore, in this embodiment, an example is provided in a case where the lectures are defined directly under the curriculum. However, the embodiment is not limited to this. For example, even in the case where the course for every six months is specified below the curriculum of each subject and a plurality of lectures are organized according to the order for each of the courses, the example of the order of the lectures may be identified. Therefore, this case is applicable to the embodiment.

The curriculum information 330 is referred to when reading out the information regarding the curriculum in processing 702, illustrated in FIG. 7.

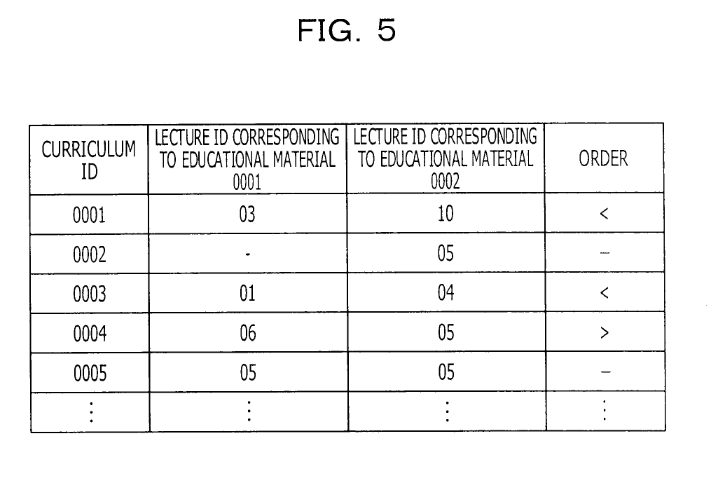

FIG. 5 illustrates an example of order determination information in the embodiment. The order determination information illustrated in FIG. 5 is an example of the order determination information 340 stored in the memory unit 300, which is illustrated in FIG. 1. The order determination information 340 is information recording with which lecture the educational materials are associated in each curriculum when selecting a set of educational materials. The order determination information 340 is created in processing 703 and processing 704 illustrated in FIG. 7, and is referred to in processing 706. In later descriptions, an educational material with an educational material ID “0001” may be represented as an educational material 0001, a curriculum with a curriculum ID “0001” may be represented as a curriculum 0001, and a lecture with a lecture ID “01” may be represented as a lecture 01.

In the order determination information 340 illustrated in FIG. 5, an example is provided in which the educational material 0001 and an educational material 0002 are selected as a set of educational materials, the relation between the lectures of each curriculum and each of the educational materials 0001 and 0002 is recorded, and furthermore, the order relation between the educational material 0001 and the educational material 0002 presumed based on the relation between the lectures and each of the educational materials 0001 and 0002 is recorded.

For example, in the second row of the second and third columns of the order determination information 340, the correspondence between the lectures in the curriculum 0001 and each of the educational material 0001 and the educational material 0002 is represented. First, in processing 704 illustrated in FIG. 7, amongst the lectures of the curriculum 0001, the educational material 0001 is determined to be most relevant to a lecture 3, and the determination result is recorded in the order determination information 340. Furthermore, in processing 704 illustrated in FIG. 7, amongst the lectures of the curriculum 0001, the educational material 0002 is determined to be most relevant to a lecture 10, and the determination result is recorded in the order determination information 340. The lecture ID represents the learning order in the curriculum. Therefore, it is presumed that the educational material 0001 corresponding to the lecture 3 is the educational material to be studied before the educational material 0002 corresponding to the lecture 10. Thus, in the second row of the fourth column in the order determination information 340, the order relation between the educational material 0001 and the educational material 0002 is recorded as “<”.

There is a case in which even when determining the relation between the lectures of each curriculum and each of the educational materials 0001 and 0002, the order relation between the educational material 0001 and the educational material 0002 may not be presumed. For example, there is a case in which the relevance between any lecture of the curriculum 0002 and the educational material 0001 may not be found. In such a case, as represented in the third row of the fourth column in the order determination information 340, “−” is recorded to represent that the educational material 0001 does not correspond to any lecture of the curriculum 0002. Thus, the order relation between the educational material 0001 and the educational material 0002 is not presumed. Therefore, the order is also recorded as “−”.

Furthermore, as an example in which the order relation between the educational material 0001 and the educational material 0002 is not able to be presumed, there is a case in which the educational material 0001 and the educational material 0002 are associated with the same lecture in a particular curriculum. As represented in the sixth row of the second and the third columns of the order determination information 340 of FIG. 5, in the case where both the educational material 0001 and the educational material 0002 correspond to the lecture 5 in the curriculum 0005, it is presumed that the order relation between the educational material 0001 and the educational material 0002 is not recognized. Therefore, the order is recorded as “−”.

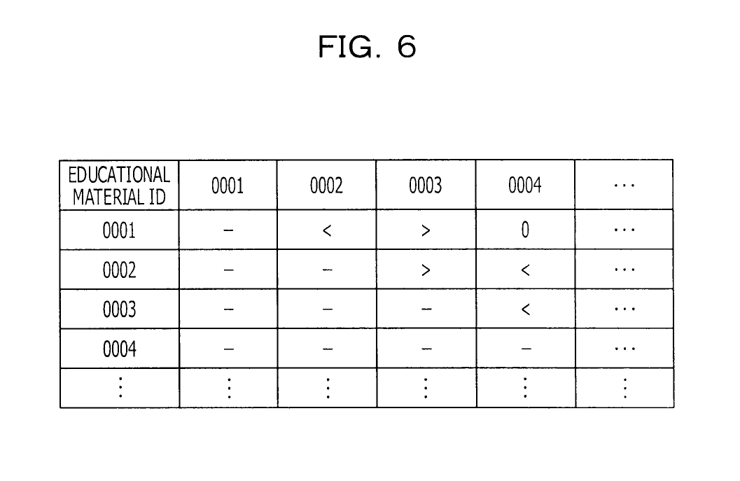

FIG. 6 illustrates an example of educational material order information in this embodiment. The educational material order information illustrated in FIG. 6 is information determined in processing 706 of FIG. 7 which manages the order relation between the educational materials, and is an example of the educational material order information 350 stored in the memory unit 300 illustrated in FIG. 1. For example, in the second row of the educational material order information 350, “<” is recorded to represent that the educational material 0002 comes after the educational material 0001. Furthermore, in the third row of the educational material order information 350, “>” is recorded to represent that the educational material 0003 comes before the educational material 0001. Moreover, in the third row of the educational material order information 350, “0” is recorded to represent that the order relation between the educational material 0001 and the educational material 0004 is not found.

FIG. 7 illustrates an example of a process in a method of determining the order relation between educational materials in this embodiment. The process illustrated in FIG. 7 is a method for determining the order relation between educational materials and is an example illustrating the overall process in the case of determining the order relation between educational materials. The process starts from Processing 700.

The similarity calculation part 210 performs processing 701, which selects a set of educational materials. In processing 701, the educational material management information 310 stored in the memory unit 300 is referred to, and a set of educational materials 750 is selected by selecting two educational materials amongst the educational materials managed by the educational material management information 310. The educational material management information related to the selected set of educational materials 750 is read out from the memory unit 300 according to the educational material management information 310.

The similarity calculation part 210 performs processing 702, which obtains a curriculum. In processing 702, the curriculum management information 320 stored in the memory unit 300 is referred to, and a curriculum 760 is obtained amongst the curriculums managed by the curriculum management information 320. The curriculum information related to the obtained curriculum 760 is read out from the memory unit 300 according to the curriculum information 330. In the embodiment, the educational materials obtained in processing 701 are necessarily used in the curriculum obtained in processing 702. That is, in the embodiment, the order relation between the educational materials is determined by determining which lecture of the curriculum each of the educational materials is most similar to, regardless of whether the educational material is being used in the curriculum or not.

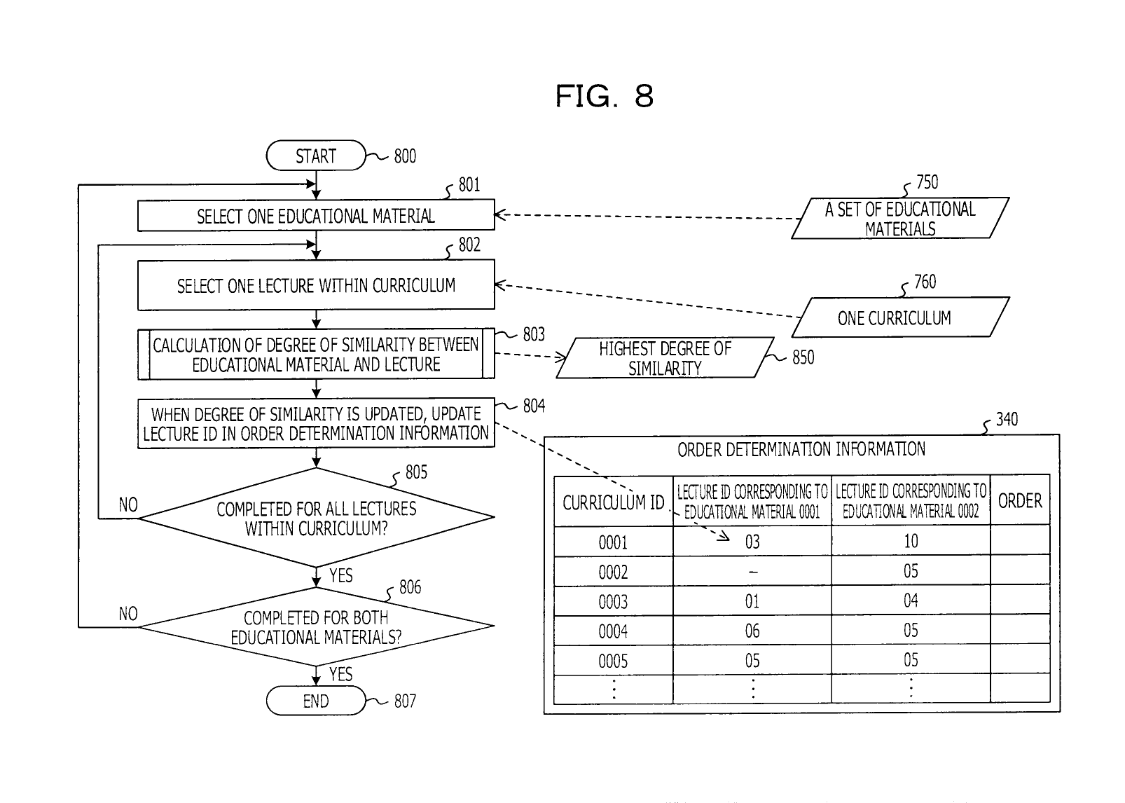

The similarity calculation part 210 performs processing 703, which calculates the similarity. In processing 703, it is determined which lecture amongst the lectures in the curriculum obtained in processing 702 is most related to each of the educational materials within the set of educational materials 750 obtained in processing 701. For example, by calculating the degree of similarity between keywords that appear in the description of the educational material contents managed in the educational material management information 310 for each educational material within the set of educational materials 750 and keywords that appear in the description of the lecture contents managed in the curriculum information 330 for the curriculum 760 for each lecture, the most relevant lecture is specified for each of the educational materials within the set of educational materials 750, amongst the lectures in the curriculum obtained in processing 702. As a result of processing 703, the association of each educational material within the set of educational materials 750 and the most relevant lecture within the curriculum 760 is stored in the memory unit 300 as the order determination information 340. A detailed example of processing 703 will be described later in conjunction with the process illustrated in FIG. 8.

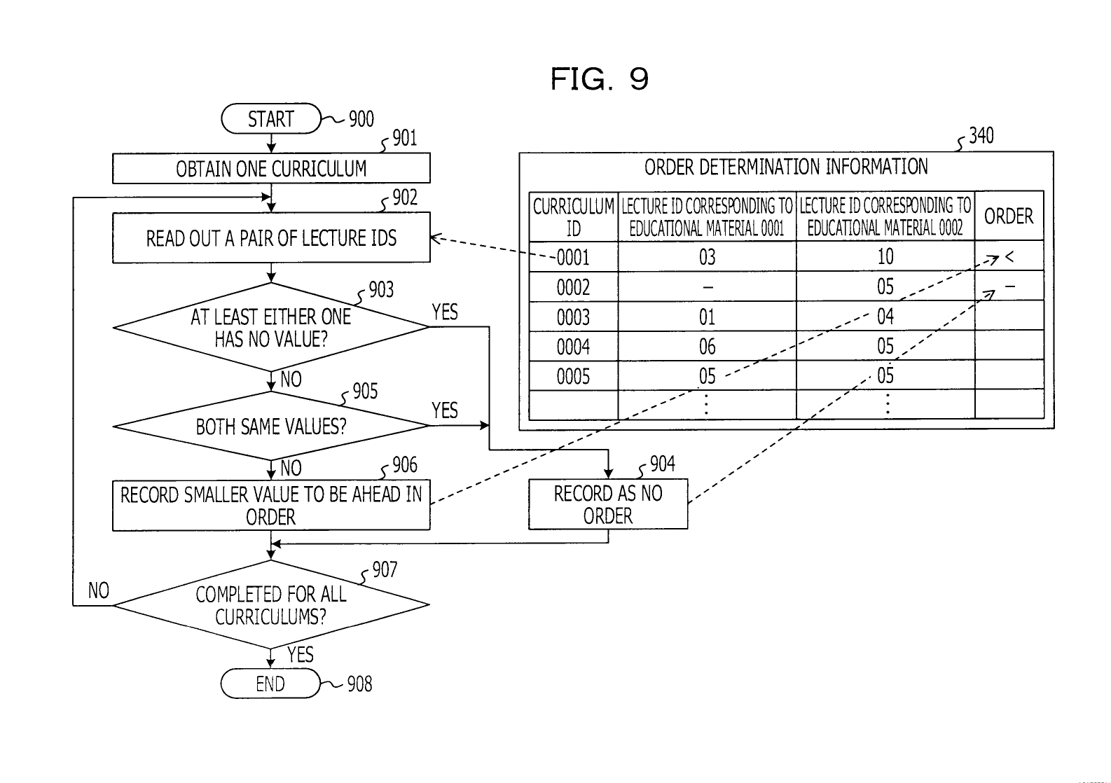

The order determination part 220 performs processing 704, which determines the order of the educational materials. In processing 704, according to the association, specified in processing 703, between each educational material within the set of educational materials 750 and the most relevant lecture within the curriculum 760, a provisional order of the educational materials within the set of educational materials 750 is determined. As a result of processing 704, a provisional order relation between the educational materials within the set of educational materials 750 is recorded in the order determination information 340 stored in the memory unit 300. A detailed example of processing 704 will be described later in conjunction with the process illustrated in FIG. 9.

The comprehensive order determination part 230 performs processing 705, which determines whether the determination has been completed for all the curriculums or not. When the determination has not been completed, the process returns to processing 702, to determine the order relation between educational materials for another curriculum. When the determination has been completed, the process proceeds to processing 707.

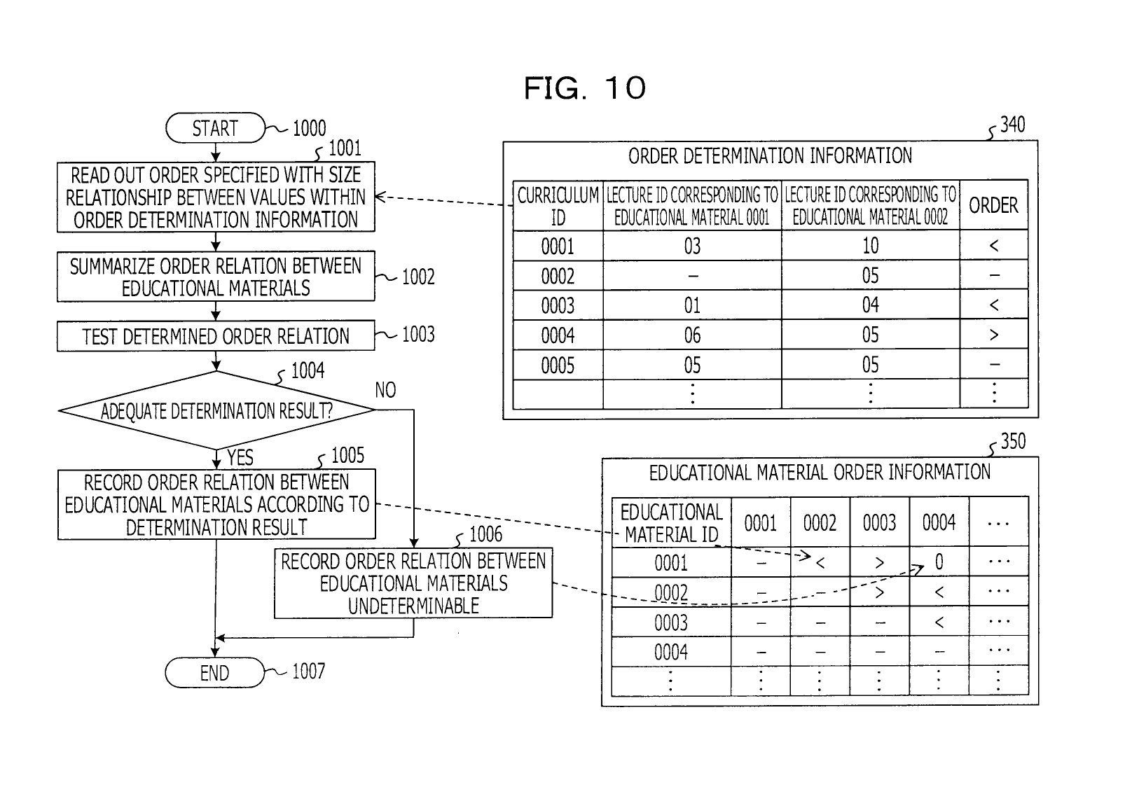

The comprehensive order determination part 230 performs processing 706, which determines the comprehensive order of the educational materials. In processing 706, by referring to the order determination information 340, the order relation between the educational materials within the set of educational materials 750 is comprehensively determined, according to the provisional order relation between the educational materials within the set of educational materials 750 determined for each curriculum in processing 703 and processing 704. As a result of processing 706, the final order relation between the educational materials within the set of educational materials 750 is stored in the memory unit 300 as the educational material order information 350. A detailed example of processing 705 will be described later in conjunction with the process illustrated in FIG. 10.

The comprehensive order determination part 230 performs processing 707, which determines whether the determination has been completed for all of the sets of educational materials. When the determination has not been completed, the process returns to processing 701, to determine the order relation of another set of educational materials. When the determination has been completed, the process proceeds to processing 708, and terminates the process illustrated in FIG. 7.

FIG. 8 illustrates an example of a similarity calculation process according to the method of determining the order relation between educational materials in this embodiment. The example of the similarity calculation process illustrated in FIG. 8 is a process performed by the similarity calculation part 210, and is a detailed example of processing 703 illustrated in FIG. 7. The process illustrated in FIG. 8 starts after processing 702 in FIG. 7 finishes.

The similarity calculation part 210 performs processing 801, which selects one of the educational materials. In processing 801, one educational material is selected amongst the set of educational materials 750 selected in processing 701 illustrated in FIG. 7.

The similarity calculation part 210 performs processing 802, which selects one of the lectures within the curriculum. In processing 802, one of the lectures is selected from the curriculum 760 selected in processing 702 illustrated in FIG. 7, based on the curriculum information 330.

The similarity calculation part 210 performs processing 803, which calculates the degree of similarity between the educational material and the lecture. In processing 803, for example, the degree of similarity between the educational material and the lecture is calculated by calculating the interrelation between a keyword that appears in the description of the educational material contents managed in the educational material management information 310 for the educational material selected in processing 801 and a keyword that appears in the description of the lecture contents managed in the curriculum information 330 for the lecture selected in processing 802.

As a more detailed example, for the calculation of the degree of similarity between an educational material and a lecture, for example, a vector space method is applied. In this method, for example, the number of appearance is calculated for each keyword that appears in the description of the educational material contents managed in the educational material management information 310. The number of appearance is used as a weighing factor for the keyword, and the description of the educational material contents is represented in vector. The description of the lecture is also represented in vector, and by calculating the inner product of the vector based on the description of the educational material contents and the vector based on the description of the lecture contents, the degree of similarity between the descriptions is determined. For example, it is determined that the larger the normalized value of the calculated inner product, the more similar the educational material and the lecture.

The calculated degree of similarity is stored in the memory unit 300 as intermediate data. Thereafter, when a higher degree of similarity is calculated in the calculation for the degree of similarity between the educational material selected in processing 801 and another lecture within the curriculum, the degree of similarity stored in the memory unit 300 is updated to the newly calculated higher degree of similarity.

When the degree of similarity is updated, the similarity calculation part 210 performs processing 804, which updates the lecture ID in the order determination information. In processing 804, in the case where the degree of similarity is updated to a higher degree of similarity in processing 803, in order to associate the lecture corresponding to the updated degree of similarity with the educational material, the lecture ID associated with the educational material is updated within the order determination information 340.

The similarity calculation part 210 performs processing 805, which determines whether the calculation of the degree of similarity for all the lectures within the curriculum has been completed or not. When it is determined that the calculation has been completed, the process proceeds to processing 806. When it is determined that the calculation has not been completed, the process returns to processing 802, in order to calculate the degree of similarity for another lecture.

The similarity calculation part 210 performs processing 806, which determines whether the calculation of the degree of similarity has been completed for both of the educational materials within the set of educational materials. When it is determined that the calculation has not been completed, the process returns to processing 801, in order to calculate the degree of similarity for another educational material. When it is determined that the calculation has been completed, the process proceeds to processing 807, which terminates the process.

FIG. 9 illustrates an example of an order determination process in the method of determining the order relation between educational materials in this embodiment. The example of the order determination process illustrated in FIG. 9 is a process performed by the order determination part 220, and is a detailed example of processing 704 illustrated in FIG. 7. The process illustrated in FIG. 9 starts after processing 703 in FIG. 7 finishes.

The order determination part 220 performs processing 901, which obtains one curriculum. In processing 901, the order determination information 340 is referred to, and a curriculum is obtained within the order determination information 340.

The order determination part 220 performs processing 902, which reads out a pair of lecture IDs. In processing 902, the pair of lecture IDs corresponding to the set of educational materials in the curriculum obtained in processing 901 is read out. For example, in the curriculum 0001, the pair of lecture IDs corresponding to the educational material 0001 and the educational material 0002 are “3” and “10”, respectively, as illustrated in FIG. 9. These values are read out in processing 902.

The order determination part 220 performs processing 903, which determines whether at least either one of the pair of lecture IDs has no value or not. In processing 903, it is determined whether at least either one of the values read out in processing 902 is missing or not. For example, as illustrated in FIG. 9, in the curriculum 0002, there is no lecture ID associated with the educational material 0001. In such a case, it is determined that at least either one of the values is not associated. When it is determined that either one of the values is missing, the process proceeds to processing 904. When it is determined that both of the values are present, the process proceeds to processing 905.

The order determination part 220 performs processing 904, which records that there is no order relation between the educational materials. In the case where the order relation between the educational materials may not be specified, in processing 904, “−” is recorded in the order column of the order determination information 340.

The order determination part 220 performs processing 905, which determines whether the values of the pair of lecture IDs are the same or not. When it is determined that the values are the same, the process proceeds to processing 904, and when it is determined that the values are different, the process proceeds to processing 906. For example, as illustrated in FIG. 9, in the curriculum 0005, both the educational material 0001 and the educational material 0002 are associated with a lecture ID “5”. Thus, the process proceeds to processing 904. In the provisional order determination based on the curriculum 0005, the order relation between the educational material 0001 and the educational material 0002 may not be presumed. Therefore, in processing 904, “−” is recorded in the order column of the order determination information 340.

The order determination part 220 performs processing 906, which records the smaller value for the pair of lecture IDs to be ahead in order. In processing 906, for example, regarding the curriculum 0001, the pair of lecture IDs corresponding to the educational material 0001 and the educational material 0002 are “3” and “10”, respectively. Therefore, it is determined that the educational material 0001 with a smaller value comes ahead in order. Thus, “<” is recorded in the order column of the order determination information 340.

The order determination part 220 performs processing 907, which determines whether determination has been completed for all the curriculums or not. In the case where the determination has not been completed, the process returns to processing 901 in order to determine the order relation between the educational materials for another curriculum. In the case where the determination has been completed, the process proceeds to processing 908, and terminates the process.

FIG. 10 illustrates an example of a comprehensive order determination process in the method of determining the order relation between educational materials in this embodiment. The example of the comprehensive order determination process illustrated in FIG. 10 is a process performed by the comprehensive order determination part 230, and is a detailed example of processing 705 illustrated in FIG. 7. The process illustrated in FIG. 10 starts after processing 704 in FIG. 7 finishes.

The comprehensive order determination part 230 performs processing 1001, which reads out the order specified with size relationship between values within the order determination information. In processing 1001, the result of the specified order within the order determination information 340 is read out.

The comprehensive order determination part 230 performs processing 1002, which summarizes the order relation between the educational materials. In processing 1002, the number which comes earlier in order relation is summarized for each of the educational materials in accordance with the order read out in processing 1001.

The comprehensive order determination part 230 performs processing 1003, which tests the determined order relation. For example, by following the numbers summarized by processing 1002, even when there are many cases where it is counted that one educational material comes earlier in order than another educational material, there is a possibility that the order relation may have been determined by chance. Therefore, in processing 1003, the numbers summarized in processing 1002 are tested. This method of testing the comprehensive order relation between the educational materials may be performed with, for example, a chi-square test in processing 1003. However, the embodiment is not limited to this.

The comprehensive order determination part 230 performs processing 1004, which determines whether the determination result is adequate or not. In processing 1004, based on the result tested by processing 1003, it is determined whether the comprehensive order relation between the educational materials is adequate or not. For example, the order relation may be determined more appropriately, by considering the case where it had been determined by chance that the order is earlier, for example, by determining whether the result is less than 1 percent or not, based on the result of the chi-square test performed in processing 1003. In the case where the determination result is adequate, the process proceeds to processing 1005, and in the case where the determination result is not adequate, the process proceeds to processing 1006.

The comprehensive order determination part 230 performs processing 1005, which records the order relation between the educational materials according to the determination result. In processing 1005, the order relation of the educational material having a larger number of times the educational material comes earlier in the order relation summarized in processing 1002, is recorded as earlier in the educational material order information 350.

The comprehensive order determination part 230 performs processing 1006, which records that the order relation between the educational materials is undeterminable. In processing 1006, “0” is recorded in the educational material order information 350 which represents that the order relation between the educational materials is undeterminable, following the result in processing 1005 which determines that the order relation between the educational materials may not be determined. When processing 1005 or processing 1006 is completed, the process illustrated in FIG. 10 is terminated.

As described above, according to the embodiment, even in the case where the learning order is not associated amongst multiple educational materials, by specifying which lecture of a curriculum an educational material is similar to through mediating information about the curriculum in which the lecture order is defined, the order relation between the educational materials is specified, and an efficient learning order based on the presumed order relation may be presented. Furthermore, according to the learning order of the educational materials specified in the embodiment, for example, learning order of multiple educational materials, such as all of the educational materials, may be proposed. Therefore, a shortest learning route with the highest learning efficiency may also be proposed.

For example, even when an educational material is not used in a lecture defined in a particular curriculum, based on that the curriculum is created in accordance with an example of the recommended learning order, by specifying which lecture within the curriculum the educational material is most related to, it is determined which order of the recommended learning order the educational material corresponds to. Furthermore, it is also determined for other educational materials which order of the learning order the educational materials correspond to, and according to the difference in the order, the order relation between the educational materials is specified.

As mentioned above, even in the case where the order relation between the educational materials is not previously specified, or in the case where the educational materials and the curriculum are not associated with each other, according to the embodiment, by specifying the relation between the educational materials and the learning order within the curriculum, the order relation between the educational materials is presumed, and an efficient learning order may be presented.

For example, in the case where anyone may become a provider of educational materials and anyone may use registered educational materials, the order relation between the educational materials is not specified because the creators of the educational materials are different. In such a case, even when it is possible to select freely among a large amount of educational materials, a user of the educational materials is not be able to determine the learning order of the educational materials. Even in such a case, according to the embodiment, an efficient learning order may be specified. Therefore, the user may use the large amount of educational materials efficiently.

Furthermore, according to the embodiment, even the order relation between educational materials which are created amongst different universities may be specified. Therefore, cross-cutting studies across different universities may be made possible, providing an opportunity for comprehensive learning programs which may suit the desire of the users of the educational materials.

When a user uses an educational material created by a certain creator, according to the embodiment, the ability to provide another creator's educational material with information on whether the educational material is to be studied prior to or after a certain educational material, is preferable not only for the user of the educational materials, but also for the creators of the educational materials, because the opportunity for the educational materials to be used may increase. In such a case, the educational materials may be presented in accordance with the progress of a user. Therefore, it is expected that the user satisfaction will further be enhanced. For this reason, it is possible to recommend the usage of the method to determine the order relation between educational materials to the creators that supply the educational materials. Thus, it may be said that the method to determine the order relation between educational materials is also preferable for business owners to provide and operate the method.

Furthermore, in the case where a user has decided that a review is desirable as a result of studying using an educational material created by a certain creator, by supplying educational materials according to the learning order in the embodiment, the user may be able to review the subject by using educational materials which are different from the educational materials created by the creator that the user has already studied, thus increasing the learning efficiency.

When educational materials are combined into each subject, there may be a case in which the learning items to be reviewed may not be found. For example, knowledge of calculus of mathematics may be prerequisite for studying physics, or knowledge of statistics may be desired for studying biology. That is, if the lectures are merely categorized by simple subjects, there may be a possibility that study opportunities which overlap between subjects may be missed, even when the creator is the same.

According to the embodiment, the order relation between the educational materials is determined based on the degree of similarity between the educational materials and not dependent on the subject. For example, for the review of an educational material in physics, it is possible to specify and propose a desired educational material in mathematics.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A system comprising:
a database configured to store pieces of data each of which corresponds to learning materials;
an apparatus configured to:
obtain order information defining relationship between a plurality of learning items and learning order for the plurality of learning items,
identify which learning item among the plurality of learning items each of the pieces of data relates to, and
determine order relation between the pieces of data based on order of each the identified learning item in the order information; and
a device configured to access the pieces of data each of which corresponds to the learning materials based on the determined order relation.

2. An apparatus comprising:
a memory; and
a processor coupled to the memory and configured to:
obtain order information defining a relationship between a plurality of learning items and learning order for the plurality of learning items;
identify which learning item among the plurality of learning items pieces of data each of which corresponds to learning materials relates to; and
determine order relation between the pieces of data based on order of each the identified learning item in the order information.

3. The apparatus of claim 2, wherein
each of the learning materials is provided by different providers.

4. The apparatus of claim 2, wherein
the learning order defined in the order information is order of lectures included in a curriculum.

5. The apparatus of claim 4, wherein
the curriculum relates to mathematics.

6. The apparatus of claim 4, wherein
the lectures included in the curriculum are lectures provided by a university.

7. The apparatus of claim 4, wherein
one of the learning materials is not used in any one of the lectures included in the curriculum.

8. The apparatus of claim 2, wherein
the learning materials are educational learning materials.

9. The apparatus of claim 2, wherein
the processor is further configured to:
obtain second order information defining a second relationship between at least other learning items other than plurality of learning items and other learning order for the at least other learning items;
identify which learning item among the at least other learning items the pieces of data each of which corresponds to learning materials relates to; and
tally orders of each the identified learning item in the order information and the second order information,
wherein the processor is configured to determine the order relation based on the tallied orders.

10. The apparatus of claim 2, wherein
the processor is further configured to:
extract first keywords from each of the plurality of learning items defined in the order information;
extract second keywords from each of pieces of data each of which corresponds to the learning materials; and
calculate similarities between the first keywords and the second keywords,
wherein the processor is configured to identify which learning item among the plurality of learning items pieces of data each of which corresponds to learning materials relates to based on the calculated similarities.

11. The apparatus of claim 2, wherein
the apparatus is a single server.

12. The apparatus of claim 2, wherein
the memory is configured to store program that causes the processor to determine the order relation between the pieces of data based on the order of each the identified learning item in the order information.

13. A device comprising:
a memory; and
a processor coupled to the memory and configured to access pieces of data each of which corresponds to learning materials based on order relation between the pieces of data,
wherein the order relation is determined based on order of learning item which are associated with learning order for the learning items, and
each of the learning materials is associated with a corresponding learning item among the learning items.

14. A method comprising:
obtaining order information defining relationship between a plurality of learning items and learning order for the plurality of learning items;
identifying which learning item among the plurality of learning items pieces of data each of which corresponds to learning materials relates to; and
determining order relation between the pieces of data based on order of each the identified learning item in the order information.

15. A non-transitory computer-readable medium including a program, which when executed by a computer, causes the computer to:
obtain order information defining a relationship between a plurality of learning items and learning order for the plurality of learning items;
identify which learning item among the plurality of learning items pieces of data each of which corresponds to learning materials relates to; and
determine order relation between the pieces of data based on order of each the identified learning item in the order information.
